(19) United States
(12) Patent Application Publication
(10) Pub. No.: US 2006/0023627 A1
(43) Pub. Date: Feb. 2, 2006

(54) Computing system redundancy and fault tolerance

(76) Inventors: Anil Villait, Saratoga, CA (US); Michael Yip, Sunnyvale, CA (US); Yeeping Zhong, Milpitas, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/910,861

(22) Filed: Aug. 2, 2004

(51) Int. Cl. H04J 1/16

(52) U.S. Cl. 370/222

(57) ABSTRACT

A computing environment includes a number of nodes, one of which is a primary node that controls the operation of the computing environment and another of which is a backup node that is capable of controlling operation of the computing environment. The primary node includes a hardware management module (HMM) that controls hardware components in the computing environment. The HMM also detects and reports events relating to the hardware components. The primary node further includes a software management module (SMM) that controls instances of software components of the computing environment, and detects and reports events related to the same. A node management module (NMM) in the primary node elects the node as the primary from among the number of nodes. The NMM receives the reports of events from the HMM and SMM, and selectively transfers operational control of the computing environment to a backup node in response to the reports. A configuration management module (CMM) transfers a configuration of the computing environment to the backup node. A replication library is used in transferring a state of each of the instances of software components to the backup node.

### TECHNICAL FIELD

The invention generally relates to the field of computing systems. In particular, the invention relates to fault-tolerance and redundancy in computing equipment.

### BACKGROUND

The high demand of e-commerce and Internet applications require networks to exhibit the same reliability as the public switched telephone network. Fault-tolerance and redundancy have become critical differentiators for networking equipment. High availability networks must continue to operate when components fail unexpectedly and also during planned network upgrades or changes. Redundancy protects the network in both situations. By eliminating single points of failure network designers can create highly resilient networks for mission-critical applications. But high availability networks require more than just redundant hardware. The network must also have the ability to optimize the use of those redundant components. Network software must take into consideration the impact of component failures on the protocols that enable communications within a network.

FIG. 1 illustrates a computing environment 100 comprising a network switch architecture. The architecture includes a number of switch modules 110-140, each interconnected with the others via a switch fabric and system management module (FMM) 150. FMM 150 is responsible for switching data traffic among switch modules to which it is connected, as well as controlling operation and management of the network switch architecture.

A switch module has ports to connect the switch module to communication media that provide the physical layer connection in a communications network. The switch modules may include other components that provide other functionality, such as the ability to switch and filter local data traffic without forwarding such traffic to switch fabric and system management module 150.

The switch modules are further connected to each other via a duplicate, or redundant, switch fabric and system management module (FMM) 160. A FMM is a key component of the network switch architecture, and so it is replicated in the illustrated architecture to ensure continued operation of the network switch if the FMMs fails. FMM 150 is elected as a primary FMM, and the other FMM 160 is elected as a backup FMM. If a software or hardware fault occurs in the primary FMM 150, the primary FMM 150 transfers operational control of the network switch architecture to the backup FMM 160, which becomes the new primary FMM. The primary FMM 150 becomes the new secondary, or backup, FMM. This transfer of control is referred to herein as “failover”. If the fault condition in the new backup FMM 150 is resolved, the new primary FMM 160 may transfer operational control back to the new backup FMM 150, which becomes the primary FMM 150 once again. This transfer of control is referred to herein as “failback”.

The network switch architecture illustrated in computing system 100 may be implemented in a single network switching device, such as a chassis-based network switch device. Such a device has, for example, a common backplane to which each switch module and FMM is connected. Each switch module and FMM may be implemented on a separate “blade” inserted into a different slot of the chassis to connect to the backplane. The backplane thus interconnects the inserted switch modules to the inserted FMMs. Alternatively, one or more FMM may be implemented as an integral part of the chassis-based network switch device. In another embodiment, a FMM could be integrated with a switch module on a single blade.

While the architecture illustrated in FIG. 1 shows only two FMMs, it is appreciated that additional FMMs may be included in the architecture as well. Such FMMs are considered standby FMMs, and provide for yet further redundancy and fault-tolerance in the network switch architecture. For example, if the primary and the secondary FMMs experience a fault, a third, standby, FMM, can become the primary FMM so that the network switch architecture remains operational.

The network switch architecture illustrated in computing environment 100 may be implemented as a number of interconnected stackable network switch devices, wherein each switch module is implemented in a separate unit in the stack. A switch fabric and system management module (e.g., FMM 150) may be integrated with a switch module in a unit in the stack, or may be implemented as a separate standalone unit in the stack. External cabling connects the units in the stack.

The network switch architecture illustrated in computing system 100 may alternatively be implemented as a cluster of network devices interconnected by a network, such as a local area network (LAN) that communicate with each other using, for example, standard TCP/IP transport protocols. In such as embodiment, the FMMs, even though loosely coupled by interconnected LAN segments, act together in a coordinated fashion to deliver common switch fabric and system management services for the switch modules in the cluster. Each switch module is connected to at least two different FMMs so that the failure of one FMM does not cause the switch module to fail.

### SUMMARY

A method and apparatus for failover from a primary node to a backup node is described. The primary node includes a hardware management module (HMM) that controls hardware components in the computing environment. The HMM also detects and reports events relating to the hardware components. The primary node further includes a software management module (SMM) that controls instances of software components of the computing environment, and detects and reports related events. A node management module (NMM) receives the reports of events from the HMM and SMM, and selectively transfers operational control of the computing environment to the backup node in response to the reports. A configuration management module (CMM) transfers a configuration of the computing environment to the backup node so that if a failover occurs, the backup node does not have to recreate the configuration of the computing system. A replication library is used in transferring a state of each of the instances of software components to the backup node, so that if a failover occurs, this state information does not need to be regenerated.

### BRIEF DESCRIPTION OF THE DRAWINGS

The present invention is illustrated by way of example, and not by way of limitation, in the figures of the accompanying drawings in which:

FIG. 1 illustrates a network switching device in which an embodiment of the invention is practiced.

FIG. 2 illustrates a block diagram of an embodiment of the invention.

FIG. 3 illustrates a flow diagram of an embodiment of the invention.

### DETAILED DESCRIPTION

The invention is an implementation of a redundant, fault tolerant computing system that transfers control from a primary node to a backup node in the computing system when the primary node encounters a hardware or software problem, or when transfer of control is dictated by a management module of the computing system, for example, in response to input received from a user. It is contemplated that failover from the primary node to the backup node can be accomplished without loss of data. For example, in a computing system that comprises a network switch architecture in which separate, redundant switch fabric and system management modules (FMMs) are the primary and backup nodes, it is contemplated that failover can be achieved in a manner such that any established data traffic flows will continue to be processed by the network switch architecture without packet loss occurring.

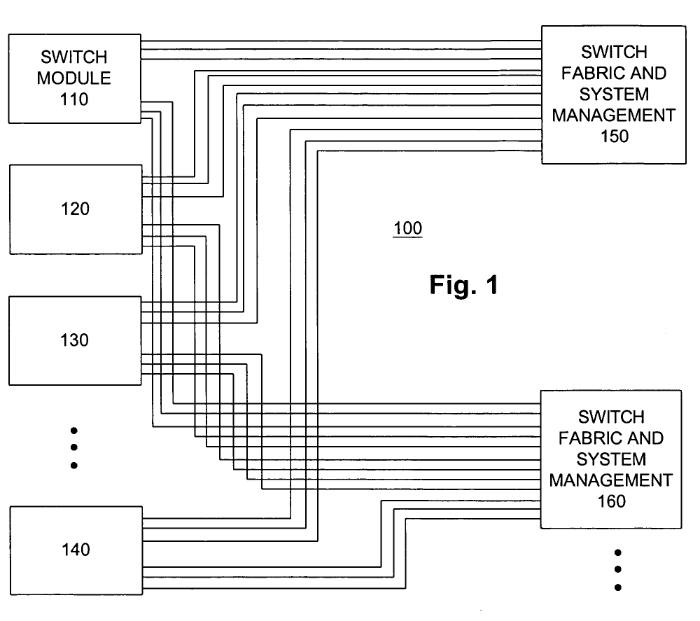

In general, an embodiment of the invention contemplates multiple nodes in a computing system. A node is an electronic computing device that has the capability of executing software routines needed to manage the computing system. In an embodiment wherein the computing system is a network switch architecture, a node is a switch fabric and system management module (FMM), e.g., FMMs 150 and 160 illustrated in FIG. 1. A primary node is a node that controls the entire computing system, e.g., FMM 150 in network switch architecture 100. FMM 150 provides all of the management functionality for switch architecture 100 including bringing up and programming switch modules 110-140, running protocols, for example, relating to bridging and routing data traffic through network switch architecture 100, and configuring the network switch architecture.

A backup node is a node, e.g., FMM 160, which receives configuration information, and hardware and process state information from the primary node, and otherwise waits for a failover to occur. The process of transferring configuration information and state information to the backup is referred to herein as “checkpointing”. The primary node “checkpoints” configuration information to the backup node first, then checkpoints the hardware and process state information thereafter.

The level of fault tolerance achieved in the computing system depends on the degree to which the backup node maintains the same configuration information and state information as is the primary node. In the event of a failover in network switch architecture 100, for example, if the backup node 160 has the same configuration information as the primary node 150, but does not have the layer 2 bridging and layer 3 routing state information, data traffic likely will be interrupted since the hardware will need to be reinitialized and all forwarding database (FDB) information will be unavailable. In such a case, while the initialization of the backup node will take only a few seconds, it could be that it will take at least a few minutes to relearn the information in the forwarding database from data traffic traversing the network.

To achieve a “hitless failover”, for example, a failover from primary FMM 150 to backup FMM 160 in network switch architecture 100 without interruption of data traffic flows, not only the network switch architecture configuration needs to be checkpointed to the backup FMM 160, but the essential data relating to the state of processes executing on primary FMM 150, such as FDB tables, Virtual Local Area Network (VLAN) tables, Internet Protocol (IP) tables, etc., is checkpointed to the backup FMM 160. Optionally, the state of hardware components is checkpointed as well.

Each node in the computing system operates independent of the other nodes. In an network switch architecture such as illustrated in FIG. 1, each FMM is an independent node. One of the two FMMs is elected a primary node, the other a secondary node, so the network switch architecture is treated as one manageable entity. In one embodiment of the invention, a node election algorithm can be used to select a primary and backup node in multiple network switch devices, such as a number of stackable network switch devices or a cluster of network switch devices. If more than two nodes exist in the network switch architecture, the node election algorithm elects standby nodes. The backup node, e.g., FMM 160, provides for faster recovery in the event of failover by avoiding arbitration between multiple nodes when the primary node fails.

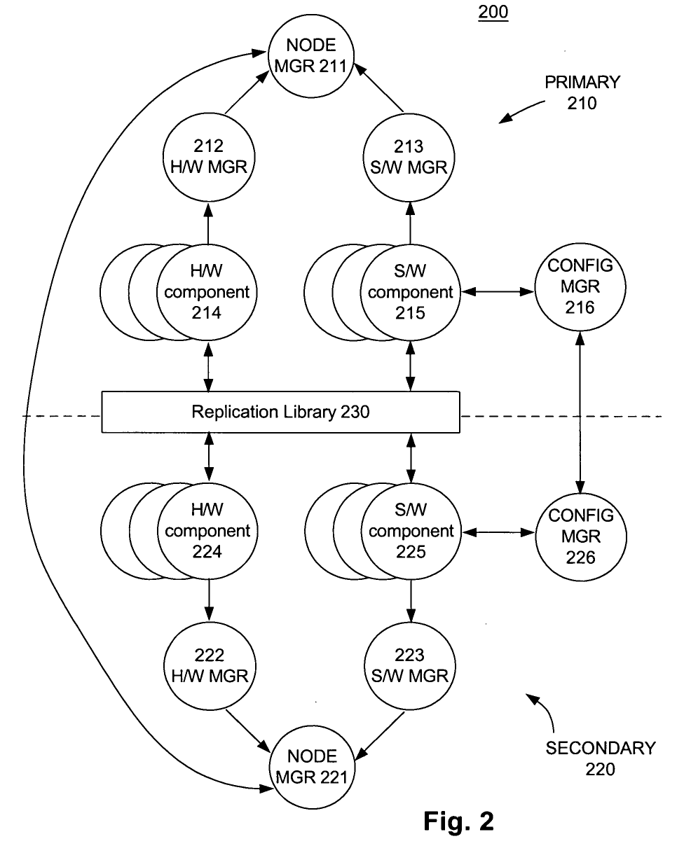

A node may be elected as the primary node based on any number of criteria that uniquely define a node and the node's health, e.g., chassis or slot ID, configured priority, quality of hardware, software functionality, data communication bandwidth, number and health of components such as power supplies, fans, etc. With reference to FIG. 2, for each node 210 and 220 in computing system 200, a respective hardware management module (HMM) 212, 224 collects information about all relevant hardware components 214, 224 and their state and forwards the same to a respective node manager module (NMM) 211, 221, and a process, or software, management module (SMM) 213, 223 collects information about all relevant processes 215, 225 running on the computing system and their state and forwards the same to the appropriate NMM 211, 221. This information gathered by each NMM can be used in the node election process.

Once a primary node is elected, fault detection occurs in much the same manner: hardware faults are detected and reported to NMM 211 by the primary node's HMM 212, whether interrupt-driven techniques or polling techniques are used to detect faults) and process failures are detected and reported to the NMM by the primary node's SMM 213.

In one embodiment of the invention, NMM 211 in the primary node 210 maintains status of the overall health of the computing system. NMM 211 receives device and process state information from the HMM and SMM respectively on node 210, and from node managers on other nodes as well, for example, NMM 221 in backup node 220. Since the NMM 221 receives device and process state information from HMM 222 and SMM 223 and reports the same to NMM 211, NMM 211 has a complete and unified view of the state of all hardware devices 214, 224 and software processes 215, 225 in the computing system 200.

NMM 211 uses the health of the hardware and software components, as determined from reports received from HMM 212, SMM 213 and NMM 221, to decide whether to failover from primary node 210 to the secondary node 220. In one embodiment of the invention, NMM 211 may be instructed to failover based on a user or network manager policy that prefers to failover versus a hardware component reset or software process restart.

As briefly described above, checkpointing is the process of state transfer from the primary node to the backup node, to provide for fast state recovery in the event of failure of the primary node. In one embodiment of the invention, software processes executing on the primary node are responsible for replicating their own data and state to a peer process on the backup node. Given this independence, such software processes can implement their own checkpointing algorithms. For example, software routines could checkpoint data synchronously or asynchronously, using reliable or unreliable data transfer protocols, according to their own checkpointing interval or schedule, depending on factors such as the impact that loss of relevant data would have on the health of the overall system in the event of a failover.

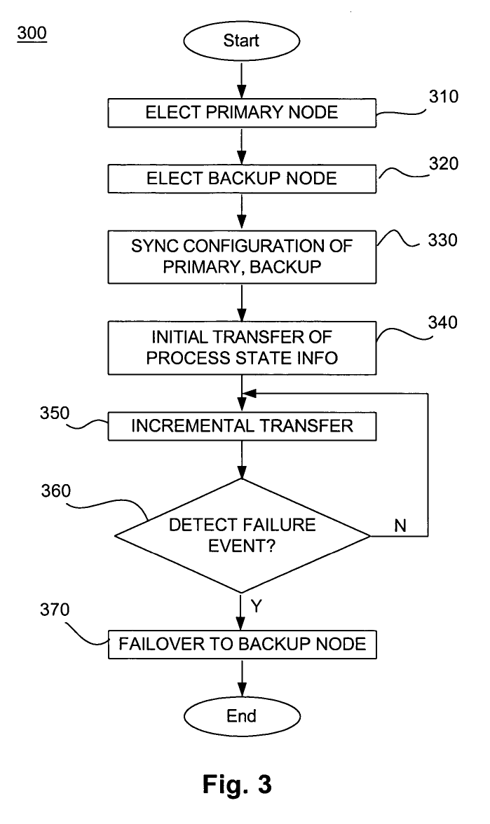

Replication of the configuration and state information from the primary to backup node is accomplished in stages, according to one embodiment of the invention. With reference to the flow diagram in FIG. 3, once the primary node and backup node have been elected at 310 and 320, the backup node is synchronized with the same configuration information as maintained by the primary node, at 330. Optionally, any standby nodes receive the configuration information as well. The backup node and any standby nodes may either update their existing configuration with the configuration from the primary node. Alternatively, the backup and/or the standby nodes may keep the configuration received from the primary separate from the configuration saved at the backup/standby node, unless, for example, a network administrator executes a command instructing the backup and/or standby node to update or replace their configurations with the configuration received from the primary node. The synchronization of the configuration information ideally should occur as a single transaction or atomic operation, that is to say, either the entire configuration of the computing system should be transferred successfully to the backup node, or not at all.

To simplify the checkpointing performed by each process, synchronization of configuration information is separated from the processes and is instead handled by configuration management module (CMM) 216 on the primary node 210, in direct communication with CMM 226 on the backup node 220.

Once the configuration on the backup node is synchronized, any changes in the current configuration on the primary node is checkpointed to the backup node and incorporated into the backup node's configuration. For example, when a user types a command, for example, in a command line interface to the computing system, causing a need to change the configuration of the system, the CMM 216 sends the command first to the backup node, in particular, to CMM 226 in backup node 220. CMM 226 forwards the command to any appropriate process 225 on the backup node, receives an acknowledgement the command was executed on the process, and sends a response indicating the configuration on the backup node has been updated. Then the command is executed on the primary node. For example, CMM 216 may forward the command received from the user to the appropriate process 215 where it is executed. Any resulting change in state is then checkpointed by the process 215 to a peer process 225 running on the backup node. If a failover occurs, the backup node will thus be ready to use the primary's current configuration.

The configuration maintained in a standby node, for example, in a flash memory is accessible to the standby node, may not be current if not recently updated by a network manager performing a save operation or the like, at the time of a failover of both the primary and backup nodes. In such a case, the standby node will use the stored configuration.

Returning back to 330 in FIG. 3, once configuration is initially synchronized, state information is then transferred from the primary node to the backup node at 340. The initial transfer of state information following configuration synchronization is referred to herein as an initial bulk checkpoint process. As indicated above, individual processes are responsible for checkpointing their own in-memory states to the backup node.

In one embodiment of the invention, due to dependencies between processes and the configuration of the computing system, the transfer of state information only occurs after the configuration is synchronized, and for those processes that depend on other processes, the transfer of a dependent process' state information only occurs after any processes on which it depends have transferred their state information. A process indicates when it has completed its initial bulk checkpoint. The indication of such triggers the next process that depends on the data that was checkpointed to proceed with its initial bulk checkpoint. The transfer of state information is performed in this manner in order to ensure orderly behavior of the processes.

As an example, in the computing environment contemplated in FIG. 1, CMM 216 first checkpoints configuration from the primary node, e.g., FMM 150, to backup node, e.g., FMM 160. If HMM 212 is a process that depends on CMM 216, only after CMM 216 completes checkpointing configuration does HAM 212 checkpoint its state to counterpart HMM 222. A software component, for example, a VLAN manager process, that depends on process HMM 212 then checkpoints its state to backup node 160, and so on.

At 350, once a process has transferred all of its state information to the backup node, any new changes in state related to the process will be checkpointed immediately. This is referred to herein as incremental checkpointing. Unless the primary node detects a fault condition, failure event, or instructions to failover to the secondary node at 360, an embodiment of the invention continues incremental checkpointing of configuration data and state information, as described above. If a fault condition or instructions are received to perform a failover to the backup node, a failover to the backup node occurs at 370.

As indicated above, processes in the primary node are responsible for checkpointing their state to their peer processes in the backup node. This checkpointing process is made easier by virtue of the fact that any related configuration information is first checkpointed by CMM 216 to CMM 226. Further easing the requirements on the program developer responsible for providing functionality in a software component to checkpoint its data, a replication library (RL) 230 provides for communication between software components and optionally hardware components on the primary node and on the secondary node. For example, in one embodiment of the invention, RL 230 automatically establishes a message connection, either reliable or unreliable, between peer software components on the primary and backup nodes.

Additionally, RL 230 provides a communication protocol via which the peer processes communicate, for example, layered over IPML. The RL 230 optionally contains a number of other routines that help provide a robust programmatic interface for peer processes to communicate, for example:
reporting of synchronization progress between the primary and secondary nodes;
monitoring synchronization progress of each peer process on the nodes; and
managing process dependency for initial bulk checkpointing.

It should be noted that reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented, for example, in terms of algorithms and symbolic representations of operations on data within a computer memory. These algorithmic descriptions and representations are the means used by those skilled in the data processing arts to most effectively convey the substance of their work to others skilled in the art.

An algorithm is herein, and generally, conceived to be a sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as binary digits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise apparent from the discussion throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to apparatuses for performing the operations herein. These apparatuses may be specially constructed for the required purposes, or may comprise a general-purpose computer selectively activated or reconfigured by a computer program stored in the computer. Such a computer program may be stored in a machine-readable storage medium, such as, but not limited to, any type of magnetic or other disk storage media including floppy disks, optical storage media, CD-ROMs, and magnetic-optical disks, read-only memories (ROMs), random access memories (RAMs), EPROMs, EEPROMs, magnetic or optical cards, flash memory devices; electrical, optical, acoustical or other form of propagated signals (e.g., carrier waves, infrared signals, digital signals, etc.), or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. In addition, the present invention is not described with reference to any particular programming language. It will be appreciated that a variety of programming languages may be used to implement the teachings of the invention as described herein.
What is claimed is:

1. In a computing environment having a plurality of nodes, one of which is a primary node controlling operation of the computing environment and another of which is a backup node capable of controlling operation of the computing environment, the primary node comprising:
a hardware management module that controls a plurality of hardware components of the computing environment, and detects and reports events related thereto;
a software management module that controls a plurality of instances of software components of the computing environment, and detects and reports events related thereto;
a node management module that elects the primary node from among the plurality of nodes, receives the reports of events from the hardware and software management modules, and selectively transfers operational control of the computing environment to the backup node responsive to the received reports of events;
a configuration management module that transfers a configuration of the computing environment to the backup node; and
a replication library for use in transferring a state of each of the instances of software components to the backup node.

2. The primary node of claim 1, wherein the primary node comprises a network device management module and the plurality of nodes comprise at least one other network device management module.

3. The primary node of claim 2, wherein the computing environment is a chassis-based network device comprising the network device management module and the at least one other network device management module, and wherein the primary node controlling operation of the computing environment comprises the network device management module controlling operation of the chassis-based network device.

4. The primary node of claim 2, wherein the computing environment includes a plurality of stackable network devices, wherein one of the network devices comprises the network device management module and another stackable network device comprises the at least one other network device management module, and wherein the primary node controlling operation of the computing environment comprises the network device management module controlling operation of the plurality of network devices in the stack.

5. The primary node of claim 2, wherein the computing environment includes a cluster of network devices, wherein one of the network devices in the cluster comprises the network device management module and another network device in the cluster comprises the at least one other network device management module, and wherein the primary node controlling operation of the computing environment comprises the network device management module controlling operation of the network devices in the cluster.

6. The primary node of claim 1, wherein the hardware management module that controls a plurality of hardware components of the computing environment comprises a hardware device manager that controls switch modules of a network switch device.

7. The primary node of claim 1, wherein the software management module that controls a plurality of instances of software components of the computing environment comprises a process manager routine that controls instances of switching protocols in a network device.

8. The primary node of claim 1, wherein the node management module that selectively transfers operational control of the computing environment to the backup node responsive to the received reports of events transfers operational control to the backup node responsive to receiving a report of a failure event from one of the software management module and the hardware management module.

9. In a computing system having a plurality of nodes, one of which is a primary node controlling operation of the computing environment and another of which is a backup node capable of controlling operation of the computing system, a method of transferring operating control from the primary node to the backup node, the method comprising:
electing the primary node and the backup node from among the plurality of nodes;
transferring a configuration of the computing system from the primary node to the backup node;
transferring a state for each of instances of hardware and software components in the computing system from the primary node to the backup node;
detecting at the primary node and reporting to the backup node events relating to the hardware and software components of the computing system; and
transferring operational control of the computing environment to the backup node responsive to the backup node receiving a report indicating a failure event in one of an instance of a hardware or software component.

10. The method of claim 9, wherein electing the primary node and the backup node from among the plurality of nodes comprises electing a first network management module in a network switch device as a primary node and a second network management module in the network switch device as the backup node.

11. The method of claim 10, wherein transferring a configuration of the computing system from the primary node to the backup node comprises transferring a configuration file maintained by the first network management module to the second network management module, the configuration file providing content indicating the configuration of the network switch.

12. The method of claim 11, wherein the network switch device comprises one of a chassis-based network switch device, a plurality of stackable network switch devices, and a cluster of network switch devices.

13. A primary node comprising:
a hardware management means for controlling a plurality of hardware components of a computing environment, and detecting events related to the hardware components;
a software management means for controlling a plurality of instances of software components of the computing environment, and detecting events relating to the instances;
a node management means for electing the primary node from among the plurality of nodes, the primary node tracking the aforesaid events;
a means for transferring operational control of the computing environment to the backup node responsive to the tracking of the events;
a configuration management means for maintaining and transferring a configuration of the computing environment to the backup node; and
a replication means for transferring a state of each of the hardware components and instances of software components to the backup node.
